(19) United States
(12) Patent Application Publication
(10) Pub. No.: US 2005/0114276 A1
(43) Pub. Date: May 26, 2005

(54) Personal customization of stamps

(76) Inventors: Valerie K. Hunter, Oxford, CT (US); Kenneth Daniels, Essex, CT (US)

Correspondence Address: PERMAN & GREEN, 425 POST ROAD, FAIRFIELD, CT, 06824, US

(21) Appl. No.: 10/768,872

(22) Filed: Jan. 30, 2004

Related U.S. Application Data
(60) Provisional application No. 60/523,828, filed on Nov. 20, 2003.

(51) Int. Cl. G06F 17/60

(52) U.S. Cl. 705/408; 705/401

(57) ABSTRACT

A system for customizing postage stamps in which the system includes a media gathering input device, a processing unit and an output device. The media gathering device receives the customized image that is desired to be included on the postage stamps. The processing unit analyzes the customized image for compliance with regulatory and other such standards. The output device delivers the customized stamp to the user in a form or format that allows the user to make use of the customized postage. The customized stamps could be delivered in stamp form, such as sheets or rolls, or as encrypted digital files for later printing or production.

### CROSS-REFERENCE TO RELATED APPLICATIONS

This application claims the benefit of U.S. Provisional Application No. 60/523,828, filed Nov. 20, 2003.

### BACKGROUND OF THE INVENTION

1. Field of the Invention

The present invention generally relates to generating indicia such as postage stamps, and in particular to the personal customization of stamps.

2. Brief Description of Related Developments

The ability to generate images electronically has expanded the ability to create and customize certain substrates using image files. It is possible to create digital images and reproduce those images or printable mediums.

The images that appear on postage stamps, such as those issued by the United States Postal Service (“USPS”) are subject to regulatory and compliance requirements. In most cases, the images that appear on postage stamps are predetermined and approved by the USPS. In some instances, it is possible for a customer to submit an image or graphic directly to the USPS with a corresponding request for the USPS to create a postage stamp or indicia using that custom image. Upon approval by the USPS, the USPS will manufacture a run of stamps in the desired, or a predetermined amount, that include the specific custom image for use by the customer. The use of the term “postage” or “stamps” is generally meant to refer to any type of indicia or medium that is used for proof of payment, such as for example postal indicia used in USPS mail systems. However, the present invention can apply to systems or services other than including the USPS that rely on printed indicia as a medium of value.

It would be beneficial for a user to be able to purchase customized stamps easily and efficiently while maintaining the, integrity of USPS requirements.

### SUMMARY OF THE INVENTION

The present invention is directed to a system for customizing postage stamps. In one embodiment the system includes a media gathering input device, a processing unit and an output device. The media gathering device receives the customized image that is desired to be included on the postage stamps. The processing unit analyzes the customized image for compliance with regulatory and other such standards. The output device delivers the customized stamp to the user in a form or format that allows the user to make use of the customized postage. The customized stamps could be delivered in stamp form, such as sheets or rolls, or as encrypted digital files for later printing or production.

In another aspect, the present invention is directed to an automated method to produce customized postage. In one embodiment the method comprises inputting a custom image into a user station, transmitting the custom image to a compliance center adapted to analyze the custom image for compliance with postal regulatory requirements, forming at least one custom postage stamp using the custom image if the custom image complies with the postal regulatory requirements, and transmitting the at least one custom postage stamp to the user.

In a further aspect, the present invention is directed to a computer program product. In one embodiment the computer program product comprises a computer useable medium having computer readable code means embodied therein for causing a computer to generate a customized stamp. The computer readable code means in the computer program product comprises computer readable program code means for causing a computer to gather an image to be formatted into an image for a stamp, analyze the image for compliance with regulatory requirements, format the image into a customized stamp, and transmit the customized stamp to the user for reproduction.

### BRIEF DESCRIPTION OF THE DRAWINGS

The foregoing aspects and other features of the present invention are explained in the following description, taken in connection with the accompanying drawings, wherein:

FIG. 1 is a block diagram of one embodiment of a system incorporating features of the present invention.

FIG. 2 is a block diagram of another embodiment of a system incorporating features of the present invention.

FIG. 3 is a block diagram of an architecture that can be used to practice the present invention.

### DETAILED DESCRIPTION OF THE PREFERRED EMBODIMENT(s)

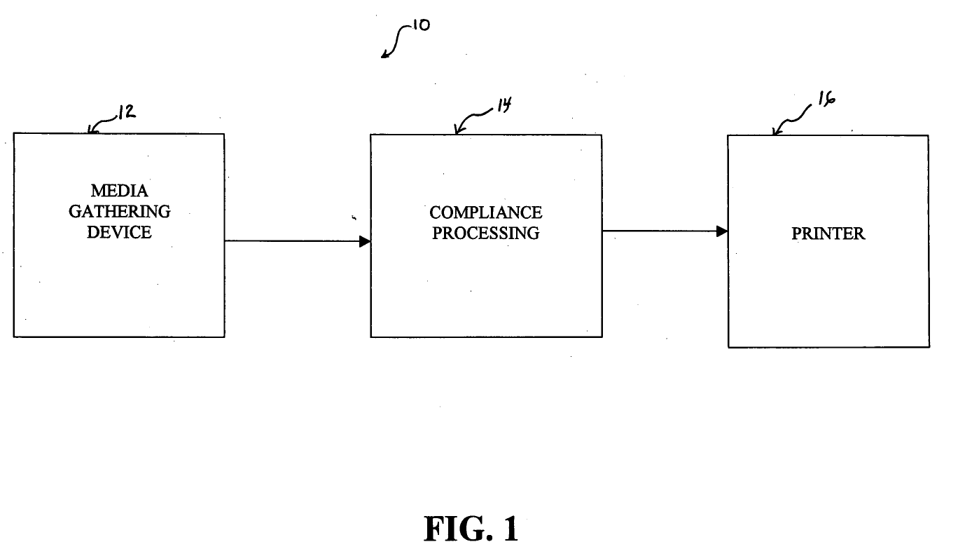

Referring to FIG. 1, a perspective view of a system 10 incorporating features of the present invention is illustrated. Although the present invention will be described with reference to the embodiment shown in the drawings, it should be understood that the present invention can be embodied in many alternate forms of embodiments. In addition, any suitable size, shape or type of elements or materials could be used.

Referring to FIG. 1, the system 10 generally comprises a media-gathering device 12, a compliance or processing unit or system 14, and an output or stamp printing system 16. Devices that could be used for the input to the media-gathering device 12 can include for example, a camera, a memory stick or compact flash card, a fax, a phone, a web site, a compact disk, a computer disk or other electronic file processing or electronic file or image storage device. The device 12 could also include a computer adapted to upload an image graphic or other file including the custom design to the compliance center 14. The media gathering device 12 can be coupled to the compliance system 14 in any suitable fashion, including a hardwire connection, a modem, a network, or wireless or optical communication means.

In one embodiment, the present invention generally comprises being able to input an image that is desired to be printed or reproduced on a postage stamp medium, process the image for compliance with regulatory requirements and output the “customized” stamp to a user. The customized stamps could include for example, a personal photo, company logo or other image or design. The disclosed embodiments allow a user to process or “create” a customized stamp “online” over a computer network, such as for example, the Internet (www). The disclosed embodiments are generally adapted to be “interactive” to allow the creation and generation of stamps, and in particular postage stamps, in a timely and efficient fashion.

In one embodiment, the picture, design, image or graphic (including text) that is desired to be placed on the stamp is inputted to the custom stamp system 10 of FIG. 1 in an electronic form. This can include for example, a scanned image, a digital photograph, a file-based image, or other electronically based input. Any type of image could be included on the stamp including for example, a photo, a graphic image, text or logo.

The image could then be transmitted to a processing center. The processing center could be an online, interactive center, or part of a Que. or kiosk, for example. The processing center would generally be adapted to examine the image or “picture” for compliance with any regulatory requirements or standards for postage or postal stamps. The processing center could also edit the image to ensure uniform quality of the final product in accordance with quality requirements.

Once the image is determined to be acceptable in terms of content and quality, the image can be formatted into the final product, or stamp. In one embodiment, a photoshop style editor could be utilized to format the image into the stamp. This could be an automated or manual process. The formatted image could be transmitted to for example, a printer system for reproduction. In an alternate embodiment, any suitable image output device or system can be utilized. The printer system can comprise any device that will take the formatted image and reproduce it into a stamp form. This could include an inkjet printer, a photo printer, a xerographic system, for example. Generally, any suitable reproduction technology or device could be used. For example, stamps of a suitable denomination could be printed with the image included thereon. The image in the form of a stamp, or item for value, could also be transmitted electronically to the user for printing in an off site location. For example, the image could be formed as part of a secure indicia for use with a postal security device or other mail system. The user could reproduce the image and indicia onto any suitable medium. The output could include a label, paper, envelope or plastic. The output could be part of two pass process where on one pass the indicia is printed and on another pass the “insecure” image is printed. The image could also be embedded in the indicia.

In one embodiment, the custom stamp system could be part of the Neopostage KIOSK™ system manufactured by Neopost, which is an on-line self-service postage kiosk that can dispense US postage over a secure web-enabled kiosk. The custom stamp system could be made a part of the KIOSK™ system and allow a customer to input a desired image to a media gathering device in the KIOSK. The processing center could be located in the kiosk itself, or remotely therefrom. The stamps or postage could then be printed at the kiosk or even be adapted to be transmitted electronically and printed at the customer's home or site, for example by downloading the electronic file to a storage medium or an electronic mail account. In alternate embodiments the invention could be used with any suitable type of postage delivery system, such as a vending machine, an on-line postage delivery system, or a kiosk.

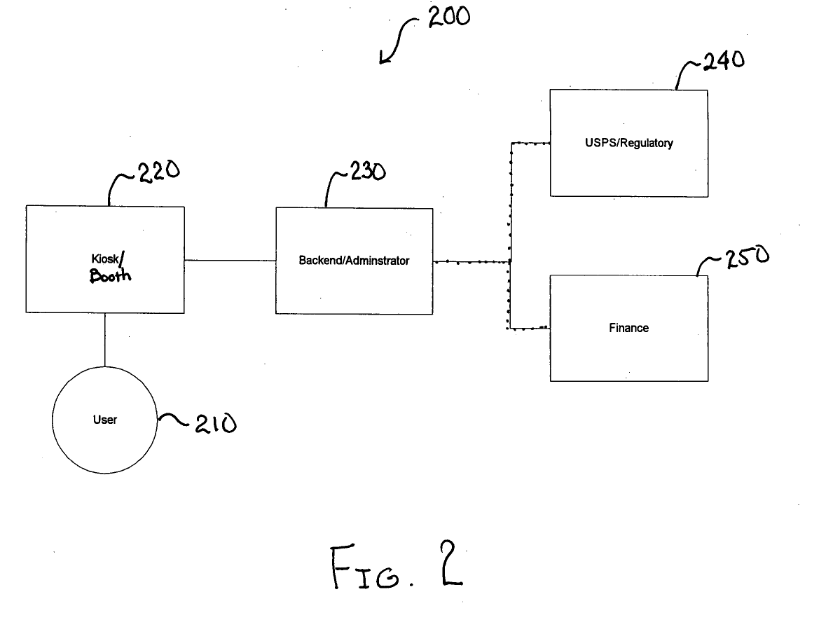

Referring to FIG. 2, in one embodiment a user 210 can go to a vending style booth or machine 220 to purchase customized stamps. The booth 220 could include for example a Kiosk or other portable station that allows a user to input information, make a purchase and receive a printed item in return. Examples of such stations and booths can include for example, ATM machine or ticket boots, such as airlines and trains. Another example of such a booth 220 is a photo booth where one can have their picture taken and printed on photo paper all in one sitting. In one embodiment, a photo booth could be specially configured to take a picture of a party and then generate a postal stamp or stamps with the picture or image on it directly to the user in the booth.

The booth 220 can be connected or coupled to a backend server or administrator 230. The connection could be a direct hardwire connection, a connection through a modem, an Internet connection, or such other suitable means of electronic communication. The backend server or administrator 230 can comprise the vendor of the custom stamp application or such other suitable agency or organization that executes the custom stamp application.

The backend server 230 can also be coupled, if required, to a regulatory or compliance agency 240, such as for example the USPS. The regulatory agency 240 could be accessed for compliance issues, to determine if a particular image or photo complies with USPS or other agency regulations and requirements. In one embodiment, the compliance or regulatory function could be internal to the backend/administrator 230, and a separate connection to the regulatory agency 240 is not required.

In one embodiment, the backend server 230 can also be connected to a financial institution 250 for processing monetary and financial transactions related to the purchase of the customized stamps. In another embodiment, the financial aspects of the present invention could be self-contained in the backend/administrator 230, and a separate connection to an external financial institution(s) may not be required.

In one embodiment, the user 210 inputs the image or photo desired to be placed on a stamp(s) into the booth 220. The booth 220 could include a graphical user interface that allows the user 210 to specifically request the type of customized stamp desired, together with the number of stamps, as well as any other information required for the processing of the custom stamp request. The booth 220 could also comprise a computer, such as a personal computer, located in a user's home, workplace, or other such convenient location. In alternate embodiments, the booth 220 can comprise any suitable means for accessing the custom stamp application, which may be served from the backend server 230. The booth 220 also allows for the user 210 to make payment for the stamps, which can included the use of cash, credit cards, debit cards or other suitable means of monetary payment. In one embodiment, the booth 220 can be adapted so that the user can access the custom stamp application by logging into a website via the booth 220. This can increase the functionality and portability of what is referred to herein as a booth 220, to be available for other applications as well.

Although a booth 220 is shown in FIG. 2 as providing the user 210 the access to the custom stamp application, in one embodiment, the user 210 can access the custom stamp application directly from a home computer, for example. Thus, in such an embodiment, the booth 220 is the user's computer or such other device that allows a user to access a website and upload or transmit files and information. The user can access a website that allows the user to access the custom stamp application after logging into the website. The application could only remain accessible to the user while the user 210 is logged in. The user 210 could submit the desired images in any suitable manner, select the desired formats for the stamps as well as the mode of delivery, whether electronic or hardcopy, and any other required information, including payment information. The user 210 could remain online, or connected to the custom stamp application until the stamps are ready for delivery. Alternatively, the user could log off the web application and login in at a later time to check on the status of the order. In one embodiment, the order for custom stamps could be sent by email to the user 210. Or, the custom stamp application could send the user 210 a notification that the custom stamps are available for delivery, in which case the user 210 might log back into the web application or site to retrieve or make arrangements for retrieval of the order.

The backend server 230 receives the custom stamp request and processes the request according to predetermined guidelines and procedures. This can include ensuring that the image submitted complies with USPS or other regulatory requirements. In one embodiment, an automated compliance system can be used that can scan the image submitted and compare the submitted image against a database of non-acceptable or non-compliant images, including any text or other graphics. In a manual system, an operator can review the submitted image for compliance. Optionally, the compliance analysis could take place at the regulatory agency 240. Once any compliance issues are resolved, the backend server 230 can process the image into a format that is suitable for reproduction on a stamp. Generally, any suitable type of image processing can be utilized to format the image. The backend server 230 can then electronically transmit the reformatted, custom stamp file to the booth 220 for reproduction.

The custom stamp can be outputted onto a label or suitable substrate for a stamp. This can include a paper, envelope, thermal or plastic substrate. In one embodiment the indicia could first be printed on the substrate and then any unsecured images could be printed on the substrate in a second pass. The booth 220 could include a suitable style of printing device that is adapted to print the stamp image and indicia on a suitable substrate.

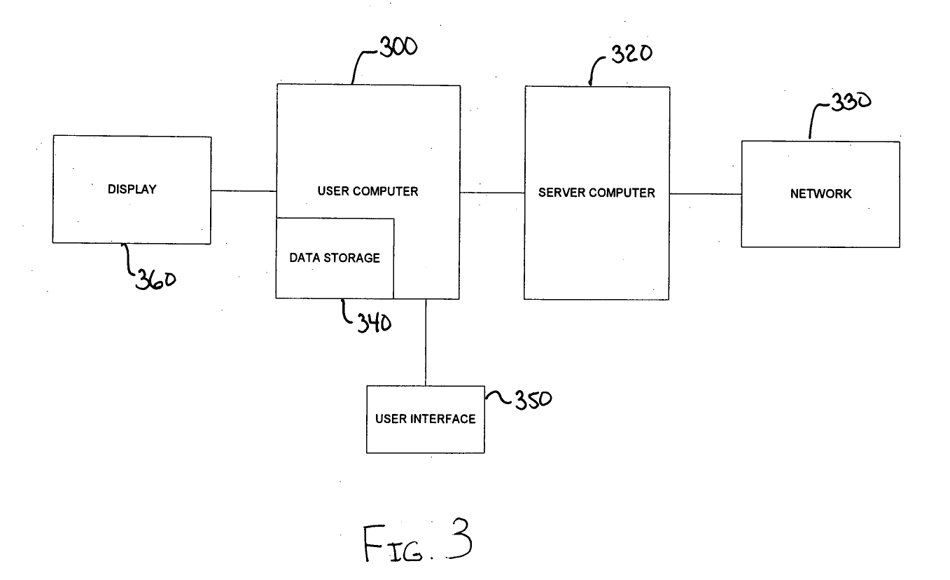

The present invention may also include software and computer programs incorporating the process steps and instructions described above that are executed in different computers. In the preferred embodiment, the computers are connected to the Internet. FIG. 3 is a block diagram of one embodiment of a typical apparatus incorporating features of the present invention that may be used to practice the present invention. As shown, a computer system 300 may be linked to another computer system 320, such that the computers 300 and 320 are capable of sending information to each other and receiving information from each other. In one embodiment, computer system 320 could include a server computer adapted to communicate with a network 330, such as for example, the Internet. Computer systems 300 and 320 can be linked together in any conventional manner including a modem, hard wire connection, or fiber optic link. Generally, information can be made available to both computer systems 300 and 320 using a communication protocol typically sent over a communication channel or through a dial-up connection on ISDN line. Computers 300 and 320 are generally adapted to utilize program storage devices embodying machine readable program source code which is adapted to cause the computers 300 and 320 to perform the method steps of the present invention. The program storage devices incorporating features of the present invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 300 and 320 may also include a microprocessor for executing stored programs. Computer 300 may include a data storage device 340 on its program storage device for the storage of information and data. The computer program or software incorporating the processes and method steps incorporating features of the present invention may be stored in one or more computers 300 and 320 on an otherwise conventional program storage device. In one embodiment, computers 300 and 320 may include a user interface 350, and a display interface 360 from which features of the present invention can be accessed. The user interface 350 and the display interface 360 can be adapted to allow the input of queries and commands to the system, as well as present the results of the commands and queries.

The present invention generally allows a user to order a customized stamp that includes for example, a personal photo or company logo, that can be printed directly at or to the user's site. The media for the custom image is gathered and processed. Compliance with regulatory requirements is ensured prior the gathered image being formatted into a stamp. The stamps, with the custom image, can then be made available to the user for delivery. The custom stamp images could be stored for order reproduction.

It should be understood that the foregoing description is only illustrative of the invention. Various alternatives and modifications can be devised by those skilled in the art without departing from the invention. Accordingly, the present invention is intended to embrace all such alternatives, modifications and variances that fall within the scope of the appended claims.

1. A system for customizing postage comprising:
a media gathering input device adapted to receive an image desired to be formed into a postage medium;
a processing unit adapted to analyze the image for content and quality;
an output device adapted to form the postage medium with the image thereon and transmit the postage medium and image to a user for reproduction.

2. The system of claim 1 wherein the processing center is an image compliance unit that is adapted to analyze the image and compare the image with an image standard in order to verify compliance with regulatory requirements.

3. The system of claim 1 wherein the output device comprises a file transfer unit adapted to receive a digital representation of the postage medium with the image and reproduce the digital representation onto a suitable medium.

4. The system of claim 1 wherein the output device comprises a printing device adapted to print the custom image onto a suitable medium.

5. An automated method to produce customized postage comprising:
inputting a custom image into a user station;
transmitting the custom image to a compliance center adapted to analyze the custom image for compliance with postal regulatory requirements;
forming at least one custom postage stamp using the custom image if the custom image complies with the postal regulatory requirements; and
transmitting the at least one custom postage stamp to the user.

6. The automated method of claim 5 wherein the custom image is inputted by downloading an image file from an imaging device.

7. The automated method of claim 5 further comprising, after transmitting the at least one postage stamp to the user if printing the at least one postage stamp on a postage stamp medium.

8. A computer program product comprising:
a computer useable medium having computer readable code means embodied therein for causing a computer to generate a customized stamp, the computer readable code means in the computer program product comprising:
computer readable program code means for causing a computer to gather an image to be formatted into an image for a stamp;
computer readable program code means for causing a computer to analyze the image for compliance with regulatory requirements;
computer readable program code means for causing a computer to format the image into a customized stamp;
computer readable program code means for causing a computer to transmit the customized stamp to the user for reproduction.
